(19) United States
(12) Patent Application Publication
(10) Pub. No.: US 2021/0150545 A1
(43) Pub. Date: May 20, 2021

(54) PROVIDING PRODUCT RECOMMENDATION IN AUTOMATED CHATTING

(71) Applicant: MICROSOFT TECHNOLOGY LICENSING, LLC, Redmond, WA (US)

(72) Inventors: Xianchao WU, Redmond, WA (US); Zhan CHEN, Redmond, WA (US); Keizo FUJIWARA, Redmond, WA (US)

(73) Assignee: MICROSOFT TECHNOLOGY LICENSING, LLC, Redmond, WA (US)

(21) Appl. No.: 16/616,869

(22) PCT Filed: May 26, 2017
(86) PCT No.: PCT/CN2017/086189

§ 371 Date: Nov. 25, 2019

(51) Int. Cl. G06Q 30/02; G06Q 30/06; G06F 16/9535; G06N 3/02; H04L 12/58

(52) U.S. Cl. CPC G06Q 30/0201; G06Q 30/0631; H04L 51/02; G06F 16/9535; G06N 3/02; G06Q 30/0251

(57) ABSTRACT

The present disclosure provides method and apparatus for facilitating product recommendation in automated chatting. In some implementations, it may be determined that a terminal device is within a predefined area, a user identity may be obtained through communicating with a chatbot on the terminal device, product recommendation information associated with the user identity may be determined and provided to the chatbot. In some implementations, a first message may be received in a chat flow, a response to the first message may be provided for indicating at least one product determined based at least on the first message, a second message including a comment on the at least one product may be received, and a user preference on the at least one product may be determined based at least on the second message.

### BACKGROUND

Artificial Intelligence (AI) chatbot is becoming more and more popular, and is being applied in an increasing number of scenarios. The chatbot is designed to simulate people's conversation, and may have automated chatting with users by text, speech, image, etc. Generally, the chatbot may scan for keywords within a message input by a user or apply natural language processing on the message, and provide a response with the most matching keywords or the most similar wording pattern to the user.

### SUMMARY

This Summary is provided to introduce a selection of concepts that are further described below in the Detailed Description. It is not intended to identify key features or essential features of the claimed subject matter, nor is it intended to be used to limit the scope of the claimed subject matter.

Embodiments of the present disclosure propose method and apparatus for facilitating product recommendation in automated chatting. In some implementations, it may be determined that a terminal device is within a predefined area, a user identity may be obtained through communicating with a chatbot on the terminal device, product recommendation information associated with the user identity may be determined and provided to the chatbot. In some implementations, a first message may be received in a chat flow, a response to the first message may be provided for indicating at least one product determined based at least on the first message, a second message including a comment on the at least one product may be received, and a user preference on the at least one product may be determined based at least on the second message.

It should be noted that the above one or more aspects comprise the features hereinafter fully described and particularly pointed out in the claims. The following description and the drawings set forth in detail certain illustrative features of the one or more aspects. These features are only indicative of the various ways in which the principles of various aspects may be employed, and this disclosure is intended to include all such aspects and their equivalents.

### BRIEF DESCRIPTION OF THE DRAWINGS

The disclosed aspects will hereinafter be described in connection with the appended drawings that are provided to illustrate and not to limit the disclosed aspects.

FIG. 1 illustrates an exemplary application scenario of a chatbot according to an embodiment.

FIG. 2 illustrates an exemplary chatbot system according to an embodiment.

FIG. 3 illustrates an exemplary user interface according to an embodiment.

FIG. 4 illustrates an exemplary scenario where an AI assistant at a partner entity provides product recommendation proactively according to an embodiment.

FIG. 5 illustrates an exemplary user interface for presenting product recommendation provided proactively by an AI assistant at a partner entity according to an embodiment.

FIG. 6 illustrates an exemplary scenario where a user quests product recommendation proactively according to an embodiment.

FIG. 7 illustrates exemplary user interfaces for a user to request product recommendation according to an embodiment.

FIG. 8 illustrates exemplary user interfaces for a user to request product recommendation according to an embodiment.

FIG. 9 illustrates exemplary user interfaces for a user to request product recommendation according to an embodiment.

FIG. 10 illustrates an exemplary AI assistant deployed at a partner entity according to an embodiment.

FIG. 11 illustrates an exemplary chat window for providing product recommendation by an AI assistant according to an embodiment.

FIG. 12 illustrates an exemplary process for generating a user profile according to an embodiment.

FIG. 13 illustrates an exemplary virtual member card for collecting user consuming information according to an embodiment.

FIG. 14 illustrates an exemplary chat window for conducting an implicit product survey according to an embodiment.

FIG. 15 illustrates an exemplary process for conducting an implicit product survey according to an embodiment.

FIG. 16 illustrates an exemplary structure of a session-based generating model according to an embodiment.

FIG. 17 illustrates an exemplary process for obtaining a candidate recommendation list according to an embodiment.

FIG. 18 illustrates an exemplary process for determining product recommendation information according to an embodiment.

FIG. 19 illustrates a flowchart of an exemplary method for facilitating product recommendation in automated chatting according to an embodiment.

FIG. 20 illustrates a flowchart of an exemplary method for facilitating product recommendation in automated chatting according to an embodiment.

FIG. 21 illustrates an exemplary apparatus for facilitating product recommendation in automated chatting according to an embodiment.

FIG. 22 illustrates an exemplary apparatus for facilitating product recommendation in automated chatting according to an embodiment.

FIG. 23 illustrates an exemplary apparatus for facilitating product recommendation in automated chatting according to an embodiment.

### DETAILED DESCRIPTION

The present disclosure will now be discussed with reference to several example implementations. It is to be understood that these implementations are discussed only for enabling those skilled in the art to better understand and thus implement the embodiments of the present disclosure, rather than suggesting any limitations on the scope of the present disclosure.

Embodiments of the present disclosure propose to provide product recommendation in automated chatting. For example, product recommendation information may be presented to users through a chatbot on a terminal device of the user, or through an AI assistant deployed at a partner entity. Herein, “partner entity” may refer to various commercial organizations that customize a product recommendation service provided by the embodiments of the present disclosure, e.g., shops, grocery stores, supermarkets, restaurants, etc. “Product recommendation information” may refer to information on products recommended by partner entities, e.g., names of recommended products, promotion information of the recommended products, etc. The promotion information may comprise discounted prices, discount ratios, coupons, etc. When product recommendation information is provided to a user, it is very likely that the user is attracted by recommend products or promotion information in the product recommendation information, and goes to a relevant partner entity to consume. Thus, the partner entity may sell products faster, especially for those products having time emergency due to closeness to expiration date.

In some implementations, an AI assistant may be deployed at a partner entity. The AI assistant may be configured for assisting the partner entity to recommend or sell products according to the embodiments of the present disclosure. For example, the AI assistant may determine product recommendation information to be provided to users, determine promotional products initiatively, collecting user consuming information, interacting with users inside the partner entity, etc.

In some implementations, a chatbot on a terminal device of a user may be configured for presenting product recommendation information to the user. The chatbot may also determine user preferences on products, which may be used for determining the product recommendation information. The user preferences may be determined through, e.g., implicit product surveys. Herein, “implicit product survey” may refer to conducting a survey about user' comments on products in an implicit way, e.g., through a session in a chat flow between the chatbot and the user. Herein, “session” may refer to a time-continuous dialog between two chatting participants, and may include messages and responses in the dialog, and “chat flow” may refer to a chatting procedure including messages and responses from two chatting participants, and may comprise one or more sessions.

In some implementations, the AI assistant at the partner entity and the chatbot on the terminal device of the user may interact with each other for providing product recommendation. For example, the chatbot may provide user identity (ID) to the AI assistant such that product recommendation information may be determined in a user specific way. The AI assistant may provide the determined product recommendation information to the chatbot such that the chatbot may present the product recommendation information to the user.

The embodiments of the present disclosure propose various approaches for initiating or triggering product recommendations. In an implementation, product recommendation may be initiated by an AI assistant at a partner entity proactively for users locating near the partner entity. In an implementation, product recommendation from nearby partner entities may be requested by a user proactively. In an implementation, product recommendation may be provided to a user who is inside a partner entity through an AI assistant deployed at the partner entity.

The embodiments of the present disclosure may lead to a better user experience of obtaining product recommendation, and may help owners of partner entities to improve their selling activities.

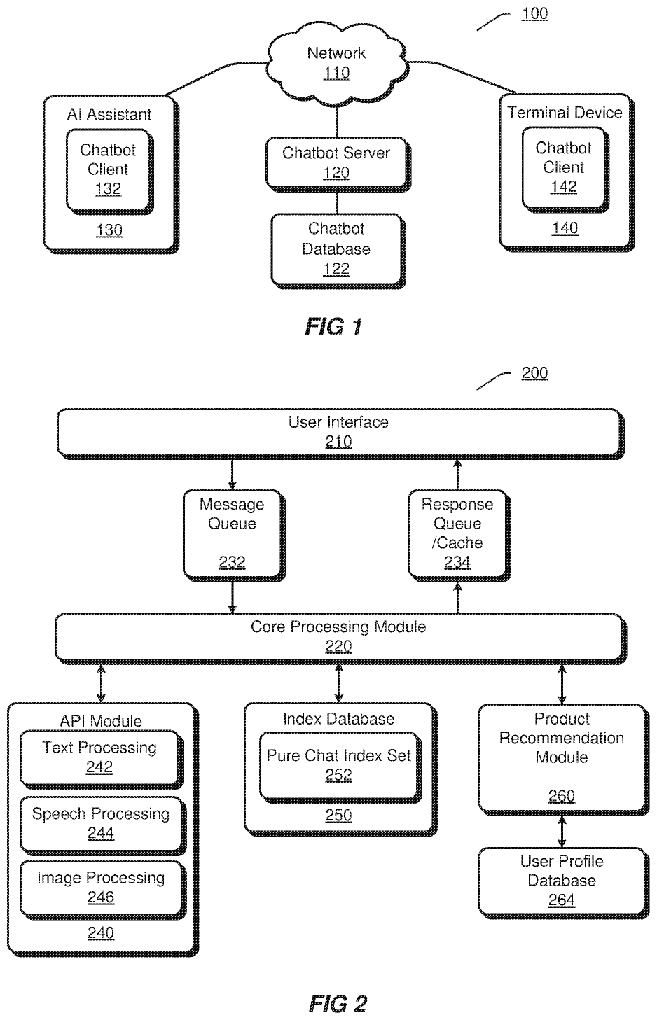

FIG. 1 illustrates an exemplary application scenario 100 of a chatbot according to an embodiment.

In FIG. 1, a network 110 is applied for interconnecting among a chatbot server 120, an AI assistant 130 and a terminal device 140.

The network 110 may be any type of networks capable of interconnecting network entities. The network 110 may be a single network or a combination of various networks. In terms of coverage range, the network 110 may be a Local Area Network (LAN), a Wide Area Network (WAN), etc. In terms of carrying medium, the network 110 may be a wireline network, a wireless network, etc. In terms of data switching techniques, the network 110 may be a circuit switching network, a packet switching network, etc.

The AI assistant 130 and the terminal device 140 may be any type of electronic computing devices capable of connecting to the network 110, assessing servers or websites on the network 110, processing data or signals, etc. For example, the AI assistant 130 and the terminal device 140 may be desktop computers, laptops, tablets, smart phones, or any other types of handhold, movable, or immovable devices. Although only one AI assistant and one terminal device are shown in FIG. 1, it should be appreciated that a different number of AI assistants and terminal devices may connect to the network 110.

In an implementation, the AI assistant 130 may include a chatbot client 132 and the terminal device 140 may include a chatbot client 142. Both the chatbot client 132 and the chatbot client 142 may interact with the chatbot server 120. For example, the chatbot client 132 or 142 may transmit messages input by users to the chatbot server 120, and receive responses associated with the messages from the chatbot server 120. However, it should be appreciated that, in other cases, instead of interacting with the chatbot server 120, the chatbot client 132 or 142 may also locally generate responses to messages input by the users. Herein, “messages” may refer to any input information, e.g., queries from the users, answers of the users to questions from the chatbot client, etc.

In an implementation, the AI assistant 130 may be deployed at a partner entity, and the chatbot client 132 may have additional functions accordingly. For example, the chatbot client 132 may determine product recommendation information to be provided to users, determine promotional products initiatively, collecting user consuming information, interacting with users inside the partner entity, etc.

In an implementation, the terminal device 140 may be used by a user, and the chatbot client 142 may have additional functions accordingly. For example, the chatbot client 142 may present product recommendation information to the user, determine user preferences on products, etc.

In an implementation, the chatbot client 132 and the chatbot client 142 may interact with each other for transferring information. For example, the chatbot client 142 may transmit user ID to the chatbot client 132, the chatbot client 132 may provide product recommendation information to the chatbot client 142, etc.

The chatbot server 120 may connect to or incorporate a chatbot database 122. The chatbot database 122 may comprise information that can be used by the chatbot server 120 for generating responses.

It should be appreciated that all the network entities shown in FIG. 1 are exemplary, and depending on specific application requirements, any other network entities may be involved in the application scenario 100.

FIG. 2 illustrates an exemplary chatbot system 200 according to an embodiment. The chatbot system 200 is introduced here to facilitate to describe logical functions and operations in a chatbot. An actual chatbot is not required to implement all the parts in the chatbot system 200. For example, the chatbot system 200 may be construed as a collection of functions of the chatbot client 132, the chatbot client 142 or even the chatbot server 120 in FIG. 1.

The chatbot system 200 may comprise a UI 210 for presenting a chat window. The chat window may be used by the chatbot for interacting with a user.

The chatbot system 200 may comprise a core processing module 220. The core processing module 220 is configured for, during operation of the chatbot, providing processing capabilities through cooperation with other modules of the chatbot system 200.

The core processing module 220 may obtain messages input by the user in the chat window, and store the messages in the message queue 232. The messages may be in various multimedia forms, such as, text, speech, image, video, etc.

The core processing module 220 may process the messages in the message queue 232 in a first-in-first-out manner. The core processing module 220 may invoke processing units in an application program interface (API) module 240 for processing various forms of messages. The API module 240 may comprise a text processing unit 242, a speech processing unit 244, an image processing unit 246, etc.

For a text message, the text processing unit 242 may perform text understanding on the text message, and the core processing module 220 may further determine a text response.

For a speech message, the speech processing unit 244 may perform a speech-to-text conversion on the speech message to obtain text sentences, the text processing unit 242 may perform text understanding on the obtained text sentences, and the core processing module 220 may further determine a text response. If it is determined to provide a response in speech, the speech processing unit 244 may perform a text-to-speech conversion on the text response to generate a corresponding speech response.

For an image message, the image processing unit 246 may perform image recognition on the image message to generate corresponding texts, and the core processing module 220 may further determine a text response. In some cases, the image processing unit 246 may also be used for obtaining an image response based on the text response.

Moreover, although not shown in FIG. 2, the API module 240 may also comprise any other processing units. For example, the API module 240 may comprise a video processing unit for cooperating with the core processing module 220 to process a video message and determine a response.

The core processing module 220 may determine responses through an index database 250. The index database 250 may comprise a plurality of index items that can be retrieved by the core processing module 220 as responses. The index items in the index database 250 may be classified into a pure chat index set 252. The pure chat index set 252 may comprise index items that are prepared for free chatting between the chatbot and users, and may be established with data from, e.g., social networks. The index items in the pure chat index set 252 may or may not be in a form of question-answer (QA) pair. Question-answer pair may also be referred to as message-response pair.

The chatbot system 200 may comprise a product recommendation module 260. The product recommendation module 260 may be configured for performing any or all operations in methods for facilitating product recommendation in automated chatting according to the embodiments of the present disclosure. The product recommendation module 260 may connect to a user profile database 262 which maintains a number of user profiles. Herein, “user profile” may refer to any information about a user that may help to determine user-specific product recommendation information. The product recommendation module 260 may determine product recommendation information based at least on the user profiles in the user profile database 262.

The responses determined by the core processing module 220 may be provided to a response queue or response cache 234. For example, the response cache 234 may ensure that a sequence of responses can be displayed in a pre-defined time stream. Assuming that, for a message, there are no less than two responses determined by the core processing module 220, then a time-delay setting for the responses may be necessary. For example, if a message input by the player is “Did you eat your breakfast?”, two responses may be determined, such as, a first response “Yes, I ate bread” and a second response “How about you? Still feeling hungry?”. In this case, through the response cache 234, the chatbot may ensure that the first response is provided to the player immediately. Further, the chatbot may ensure that the second response is provided in a time delay, such as 1 or 2 seconds, so that the second response will be provided to the player 1 or 2 seconds after the first response. As such, the response cache 234 may manage the to-be-sent responses and appropriate timing for each response.

The responses in the response queue or response cache 234 may be further transferred to the UI 210 such that the responses can be displayed to the user in the chat window.

It should be appreciated that all the elements shown in the chatbot system 200 in FIG. 2 are exemplary, and depending on specific application requirements, any shown elements may be omitted and any other elements may be involved in the chatbot system 200.

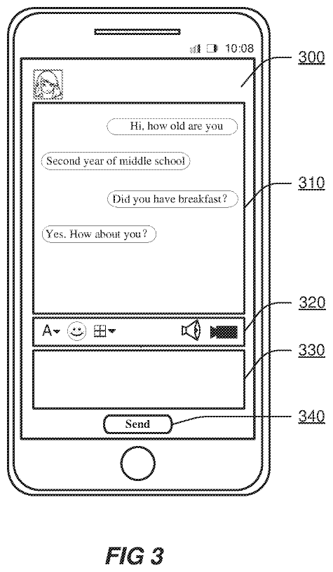

FIG. 3 illustrates an exemplary user interface 300 according to an embodiment.

The user interface 300 is shown as being included in a terminal device. However, it should be appreciated that the user interface 300 may also be included in any other devices, e.g., an AI assistant. The user interface 300 may comprise a presentation area 310, a control area 320 and an input area 330. The presentation area 310 displays messages and responses in a chat flow. The control area 320 includes a plurality of virtual buttons for the user to perform message input settings. For example, the user may select to make a voice input, attach image files, select emoji symbols, make a short-cut of the current screen, etc. through the control area 320. The input area 330 is used by the user for inputting messages. For example, the user may type text through the input area 330. The chat window 300 may further comprise a virtual button 340 for confirming to send input messages. If the user touches the virtual button 340, the messages input in the input area 330 may be sent to the presentation area 310.

It should be noted that all the elements and their layout shown in FIG. 3 are exemplary. Depending on specific application requirements, the user interface in FIG. 3 may omit or add any elements, and the layout of the elements in the user interface in FIG. 3 may also be changed in various approaches.

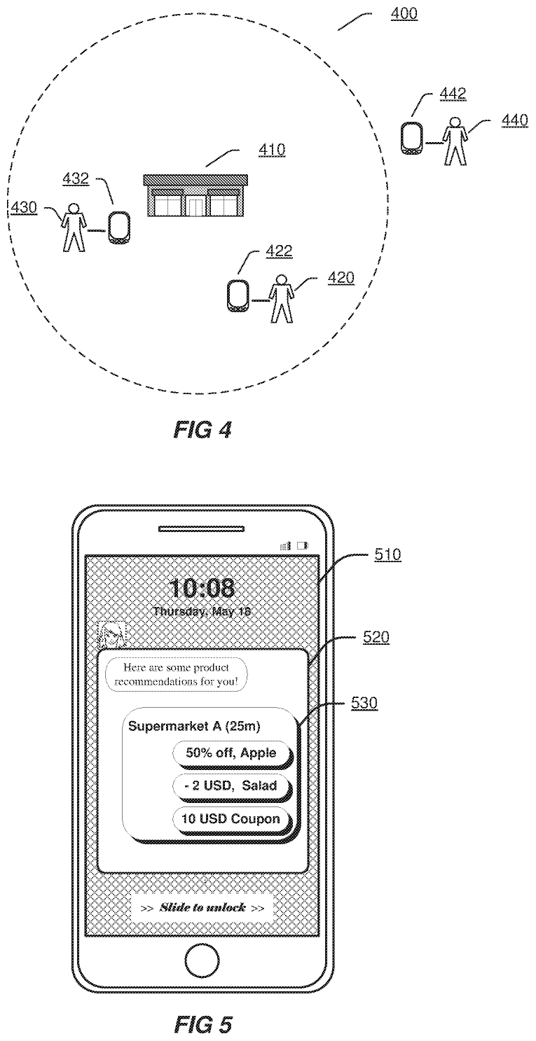

FIG. 4 illustrates an exemplary scenario 400 where an AI assistant at a partner entity provides product recommendation proactively according to an embodiment.

A detector at a partner entity 410 may be used for detecting whether terminal devices of one or more users are within a predefined area near the partner entity 410. In an implementation, the detector may be integrated in an AI assistant at the partner entity 410. Alternatively, the detector may also separate from the AI assistant. The predefined area detectable by the detector may be set according to actual requirements or be decided by communication techniques adopted by the detector. Various communication techniques may be adopted by the detector, e.g., Bluetooth, WiFi, Near Field Communication (NFC), etc. The predefined area may be, e.g., a circle with the partner entity 410 as its center point and with a predetermined radius, such as, 10 meters, 50 meters, etc. The predefined area is shown by an exemplary dashed circle in FIG. 4.

The detector may determine whether a terminal device of a user is within the predefined area based on electric signals received from the terminal device. In an implementation, the detector may determine that a terminal device is within the predefined area if the detector can receive electrical signals from the terminal device. For example, if the detector receives electrical signals from a terminal device 422 of a user 420 and a terminal device 432 of a user 430, the terminal device 422 and the terminal device 432 may be determined as being within the predefined area. While since the detector does not receive any electrical signals from a terminal device 442 of a user 440, the terminal device 442 would not be deemed as being within the predefined area. In another implementation, the detector may determine that a terminal device is within the predefined area if electrical signals received from the terminal device are above a threshold or indicate a distance within the predefined area. For example, if electrical signals received from the terminal device 422 of the user 420 and the terminal device 432 of the user 430 are above the threshold or indicate a distance within the predefined area, the terminal device 422 and the terminal device 432 may be determined as being within the predefined area. While since electrical signals received from the terminal device 442 of the user 440 are below the threshold or indicate a distance out of the predefined area, the terminal device 442 would not be deemed as being within the predefined area.

When determining that the terminal devices 422 and 432 are within the predefined area, the AI assistant at the partner entity 410 may provide product recommendation to users of the terminal devices 422 and 432. In an implementation, the AI assistant at the partner entity 410 may determine product recommendation information and send the product recommendation information to chatbots on the terminal devices 422 and 432 respectively. The chatbots on the terminal devices 422 and 432 may present the product recommendation information to the users 420 and 430 respectively. In some cases, the product recommendation information may be determined in a user specific way, and thus the terminal device 422 may receive and present product recommendation information that is specific to the user 420, while the terminal device 432 may receive and present product recommendation information that is specific to the user 430.

FIG. 5 illustrates an exemplary user interface 510 for presenting product recommendation provided proactively by an AI assistant at a partner entity according to an embodiment. The user interface 510 may be in the terminal device 422 or the terminal device 432 as shown in FIG. 4.

As shown in FIG. 5, the terminal device is in a locked screen state, and a chat window 520 is presented over the locked screen. Product recommendation information 530 provided proactively by an AI assistant at a partner entity is shown in the chat window 520. For example, the product recommendation information 530 may indicate that there is a supermarket A about 25 meters away from here, and promotions at the supermarket A include: there is a 50% discount for apples, prices for salads are reduced by 2 USD, a 10 USD coupon is provided, etc.

A user of the terminal device may be notified by, e.g., ringtones, vibrations, etc., that the product recommendation information has been received.

It should be appreciated that the user interface 510 is exemplary, and product recommendation provided proactively by an AI assistant at a partner entity may be presented on a terminal device through various appropriate user interfaces.

Moreover, it should be appreciated that in some implementations, in order to avoid troubling the user, one or more pre-conditions for presenting the product recommendation information to the user may be set, such as, a “notification” function of the chatbot having been opened on terminal device, a distance between a recommended partner entity and the user being smaller than a threshold set by the user, etc.

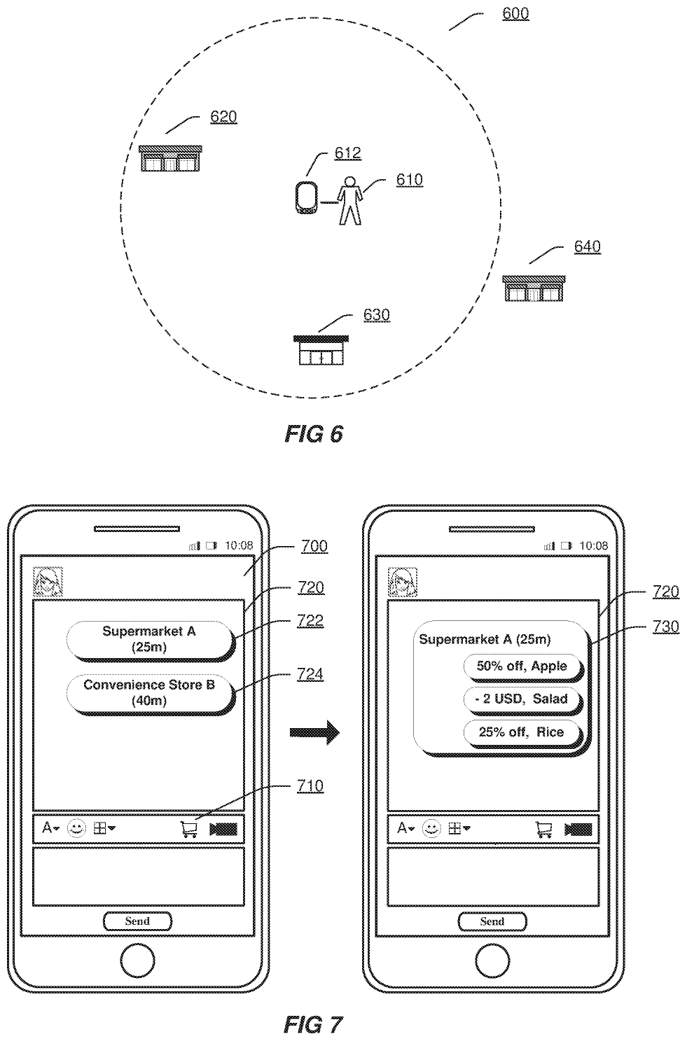

FIG. 6 illustrates an exemplary scenario 600 where a user quests product recommendation proactively according to an embodiment.

As shown in FIG. 6, a user 610 may request to obtain product recommendation proactively through a terminal device 612. The user 610 may trigger the request through various operations or gestures on the terminal device 612. For example, for the purpose of triggering the request, the user 610 may click or touch a button on a user interface of a chatbot on the terminal device, apply a finger movement on the terminal device's screen, shake the terminal device, etc.

After the request of obtaining product recommendation is triggered, the chatbot on the terminal device 612 may receive product recommendation information provided by one or more partner entities. For example, product recommendation information from a partner entity 620 and a partner entity 630 that are within a predetermined distance may be received by the chatbot on the terminal device 612, while no product recommendation information will be received from a partner entity 640 which is out of the predetermined distance. The received product recommendation information may be presented to the user 610 by the chatbot.

FIG. 7 illustrates exemplary user interfaces for a user to request product recommendation according to an embodiment.

The user may request product recommendation through a user interface 700 of a chatbot. As shown in FIG. 7, the user interface 700 may comprise a product recommendation button 710. When the user clicks or touches the button 710, icons of recommended partner entities may be presented in a chat window 720. For example, the icons of the recommended partner entities may comprise an icon 722 of a supermarket A that is 25 meters away and an icon 724 of a supermarket B that is 40 meters away.

If the user touches the icon 722, relevant promotion information 730 of the supermarket A will be presented in the chat flow 720.

It should be appreciated that the product recommendation button 710 in FIG. 7 is exemplary, the request of product recommendation may be triggered on the user interface 700 in any other approaches, e.g., through other types of buttons, through text input, through voice input, etc.

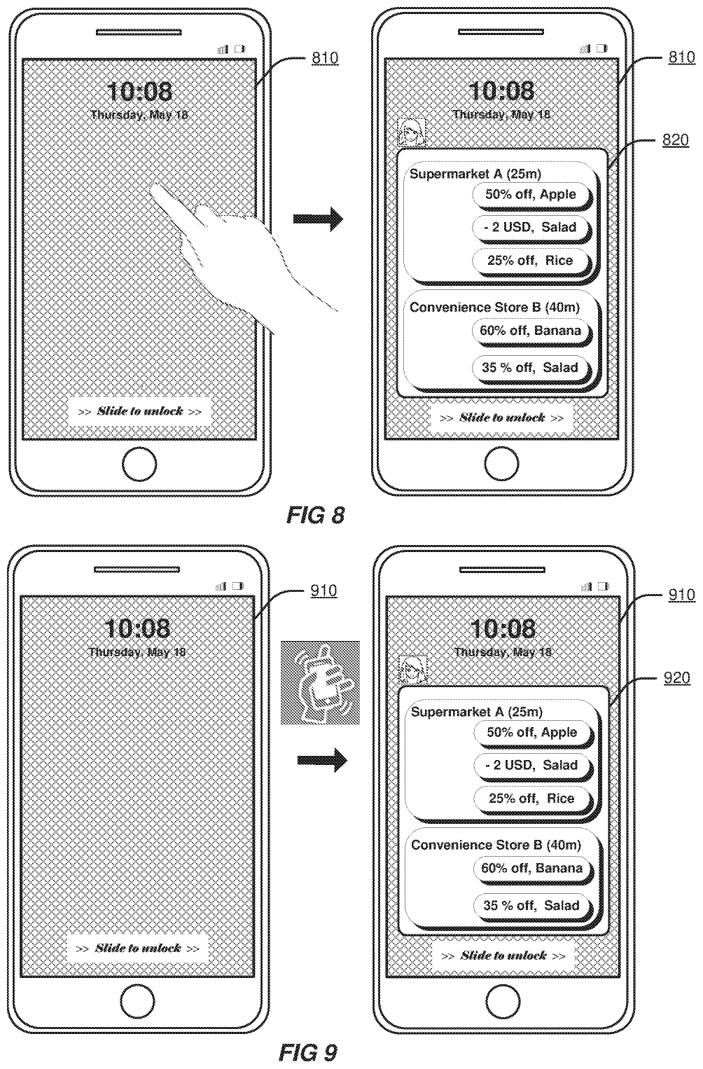

FIG. 8 illustrates exemplary user interfaces for a user to request product recommendation according to an embodiment.

As shown in FIG. 8, a terminal device is in a locked screen state. When the user touches a user interface 810 and moves his finger in a predetermined direction, e.g., downward, forward, etc., a request for product recommendation may be triggered. Then, product recommendation information may be presented in a chat window 820.

FIG. 9 illustrates exemplary user interfaces for a user to request product recommendation according to an embodiment.

As shown in FIG. 9, a terminal device is in a locked screen state. When the user makes a predetermined gesture, e.g., shaking the terminal device, etc., a request for product recommendation may be triggered. Then, product recommendation information may be presented in a chat window 920.

Although FIG. 7 to FIG. 9 show some approaches for a user to quest product recommendation proactively, it should be appreciated that the present disclosure is not limited to these approaches, but can enable the user to quest product recommendation proactively in any other predetermined approaches.

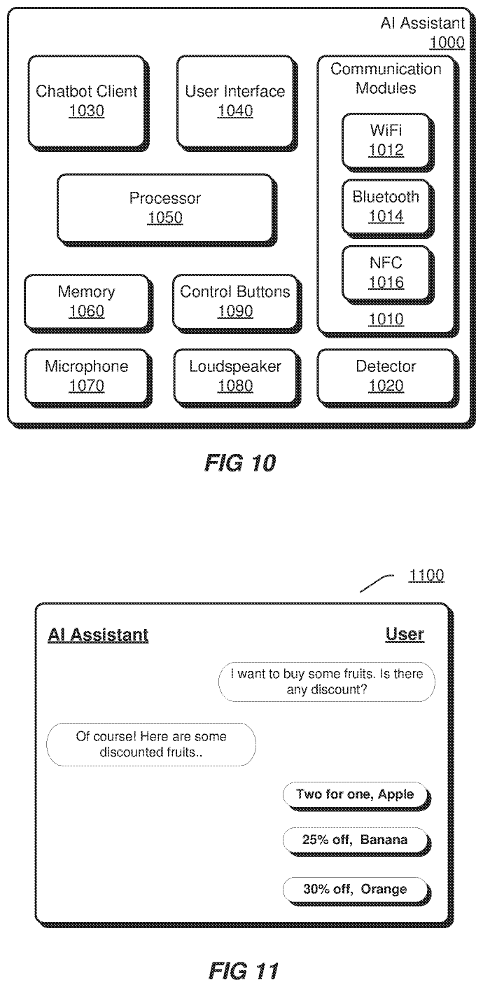

FIG. 10 illustrates an exemplary AI assistant 1000 deployed at a partner entity according to an embodiment.

The AI assistant 1000 may be implemented in various forms. In an implementation, the AI assistant 1000 may be integrated into a computer or server at the partner entity, and thus functions of the AI assistant 1000 may be performed by the computer or server. In an implementation, the AI assistant 1000 may be implemented as a separate and immovable hardware device, and placed at a designated place in the partner entity, e.g., at a gate of the partner entity, at an area near a cashier desk, at an area near shelves, etc. In an implementation, the AI assistant 1000 may be implemented as a moveable or handhold hardware device, and may be carried by a user when the user is shopping in the partner entity. In an implementation, the AI assistant 1000 may be implemented in several separate devices, each of the devices performing a part of functions of the AI assistant 1000.

As shown in FIG. 10, the AI assistant 1000 may comprise communication modules 1010. The communication modules 1010 may enable the AI assistant 1000 to communicate with other devices based on various communication techniques. For example, the communication modules 1010 may comprise a WiFi module 1012 for communicating based on the WiFi technique. The communication modules 1010 may comprise a Bluetooth module 1014 for communicating based on the Bluetooth technique. The communication modules 1010 may comprise a NFC module 1016 for communicating based on the NFC technique. Although not shown, the communication modules 1010 may further comprise any other modules for communicating based on any other communication techniques.

The AI assistant 1000 may comprise a detector 1020. As mentioned above, the detector 1020 may be used for detecting whether a terminal device of a user is within a predefined area. The detector 1020 may cooperate with the communication modules 1010 to implement detections based on various communication techniques.

The AI assistant 1000 may comprise a chatbot client 1030. The chatbot client 1030 may implement a part or all of functions of a chatbot. Thus, the AI assistant 1000 may interact with users, other chatbots, or a chatbot server through the chatbot client 1030.

The AI assistant 1000 may comprise a user interface 1040. The user interface 1040 may be used by the AI assistant 1000 for interacting with users inside the partner entity, owners or employees of the partner entity, etc.

The AI assistant 1000 may comprise at least one processor 1050 and a memory 1060. The processor 1050 may write data to the memory 1060, read data from the memory 1060, execute computer-executable instructions stored in the memory 1060, etc. For example, when executing the computer-executable instructions, the processor 1050 may implement functions of the chatbot client 1030. In some implementations, the processor 1050 may be configured for performing various processes involved in methods for facilitating product recommendation in automated chatting according to the embodiments of the present disclosure, e.g., determining product recommendation information, etc.

The AI assistant 1000 may comprise a microphone 1070 and a loudspeaker 1080. The microphone 1070 and the loudspeaker 1080 may be used for interacting with users through voices.

The AI assistant 1000 may comprise one or more control buttons 1090. The control buttons 1090 may be physical or virtual buttons for controlling modules or functions in the AI assistant 1000. For example, the control buttons 1090 may comprise a volume control button for turning up or turning down voices.

It should be appreciated that all the modules shown in the AI assistant 1000 are exemplary, and according to actual requirements, any of the modules may be omitted or replaced from the AI assistant 1000, and any other modules may be added into the AI assistant 1000.

FIG. 11 illustrates an exemplary chat window 1100 for providing product recommendation by an AI assistant according to an embodiment.

As mentioned above, the AI assistant may provide product recommendation to users who are inside a partner entity. For example, if a user inputs “I want to buy some fruits. Is there any discount?”, on a device embodying the AI assistant in the partner entity, for requests product recommendation, the AI assistant may provide corresponding fruit product recommendation information to the user on the device, such as, “Two for one, Apple”, “25% off, Banana”, “30% off, Orange”, etc.

The interaction between the AI assistant and the user may be performed through a user interface in the AI assistant. The interaction may be in various forms, e.g., texts, voices, etc.

According to the embodiments of the present disclosure, user profiles may be used for determining product recommendation information that is user specific. A user profile of a user may comprise information of this user that can help to determine product recommendation information relevant to this user. For example, the user profile may comprise user ID of the user, the user's age information, the user's gender information, the user's location information, the user's preferences on products, etc.

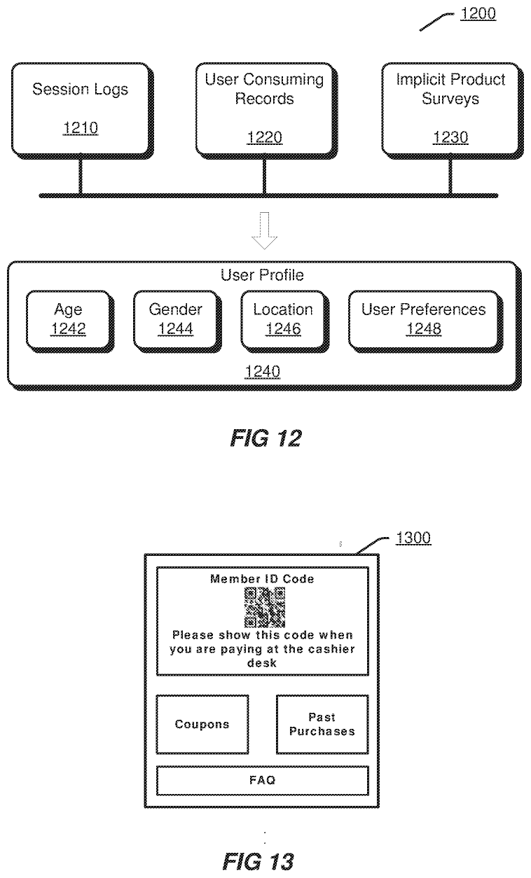

FIG. 12 illustrates an exemplary process 1200 for generating a user profile according to an embodiment. As shown in FIG. 12, session logs 1210, user consuming records 1220 and implicit product surveys 1230 of a user may be used for generating a user profile 1240 for the user.

The session logs 1210 may comprise historical free-chatting sessions between the user and a chatbot on a terminal device of the user.

The user consuming records 1220 may comprise various historical consuming information of the user, e.g., products having been bought, shop locations, consuming date and time, etc. The user consuming records 1220 may be collected by, such as, AI assistants at partner entities. For example, when the user is checking out at a cashier desk of a partner entity, the user may show a virtual or physical member card recording personal information of the user, and thus a user consuming record may be collected based on the user's member ID in the member card and current consuming behavior. FIG. 13 illustrates an exemplary virtual member card 1300 for collecting user consuming information according to an embodiment. The member card 1300 may be shown by a user at a cashier desk of a partner entity when the user is paying or using coupons. As an example, the member card 1300 may comprise a member ID code for identifying the user, a “Coupons” icon for viewing or using coupons, a “Past Purchases” icon for viewing historical purchasing records at the partner entity, and a “FAQ” icon for viewing frequently asked questions and corresponding answers.

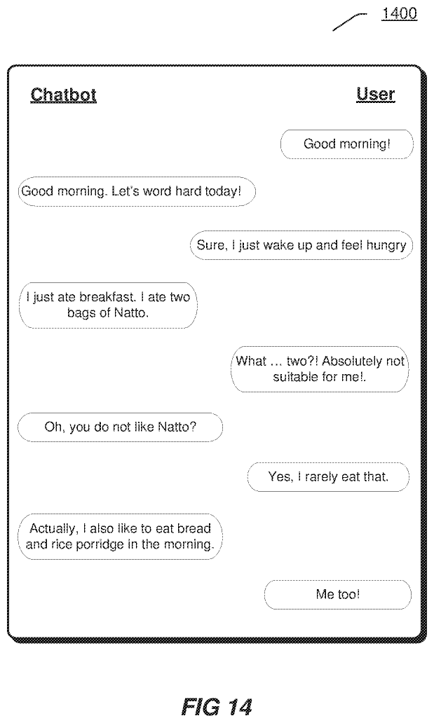

The implicit product surveys 1230 may comprise survey relevant sessions of a plurality of implicit product surveys, where an implicit product survey may refer to a survey about user's comments on products conducted through a session between the user and the chatbot in an implicit way. A survey relevant session for an implicit product survey may comprise product names provided by the chatbot and comments on the products from the user. Detailed discussion on implicit product survey will be made in connection with FIG. 14 to FIG. 16 later.

The user profile 1240 may comprise at least one of age information 1242, gender information 1244, location information 1246 and user preferences on products 1248. It should be appreciated that the user profile 1240 may further comprise any information of the user that may help to determine product recommendation information relevant to the user.

The age information 1242, the gender information 1244, the location information 1246 and the user preferences on products 1248 may be determined from at least one of the session logs 1210, the user consuming records 1220 and the implicit product surveys 1230 through respective machine learning models.

In an implementation, an age prediction model may be used for determining the age information 1242. The input to the age prediction model may be <content> or <user ID, content>. Here, “content” may refer to data from the session logs 1210, the user consuming records 1220 and the implicit product surveys 1230. e.g., a free-chatting session, a user consuming record, a survey relevant session, etc. The output of the age prediction model may be a tag of, e.g., “10+”, “20+”, “30+”, “40+”, “50+” or “60+”, where “10+” indicates an age between 10 and 20, “20+” indicates an age between 20 and 30, “30+” indicates an age between 30 and 40, and so on. The age prediction model may determine age information based on input content. For example, if a user says “I am a senior middle school student” in a session, it may be determined that the age of the user is “10+”. If a user says “I am already retired” in a session, it may be determined that the user is very likely to be “60”. If a user's consuming records indicate frequent alcohol purchases, it may be determined that the user is likely to be over 20 years old.

The age prediction model may be a Support Vector Machine (SVM) model. Training data for this SVM model may be in a form of <user ID, content, tag>, wherein “tag” is an artificially or automatically labelled age for corresponding content. Features for the SVM model may comprise at least one of:
Word n-grams: Unigrams and bigrams for words in the content are extracted.
Character n-grams: Character n-grams, e.g., 4-grams and 5-grams, are extracted for each word in the content.
Word skip-grams: Those words having no meaning in the content may be skipped so as to faster matching speed without influencing matching results. For example, for 3-grams and 4-grams in the content, one word may be replaced by * to indicate a presence of non-contiguous words.
Brown cluster n-grams: Brown clustering is used for representing words in the content, and extracting unigrams and bigrams as features. For example, “Sushi” and “Tempura” are all “Japanese food”, while “Japanese food” is a higher-level cluster compared with the specific food of “Sushi” or “Tempura”. Further, Brown clustering can be used in any other ways. For example, if a user says “I want to eat Japanese food”, then restaurants with keywords of Sushi or Tempura will also be matched since they belong to the same cluster.
Part-of-speech (POS) tags: Presence or absence of POS tag is used as a binary feature. For example, words with special meaning, e.g., nouns, verbs, adjectives, etc., may be taken into consideration.
Social network related words: Numbers of hashtags, emoticons, elongated words, and punctuations in the content are used as features.
Word2vec cluster n-grams: A Word2vec tool is used for learning, e.g., 100-dimension word embedding from a social network dataset. Then. K-means algorithm and L2 distance of word vectors may be used for clustering a million-level vocabulary into, e.g., 200 classes. These classes are used for representing generalized words in the content.

In an implementation, a gender classification model may be used for determining the gender information 1244. The input to the gender classification model may be <content> or <user ID, content>. Here, “content” may refer to data from the session logs 1210, the user consuming records 1220 and the implicit product surveys 1230, e.g., a free-chatting session, a user consuming record, a survey relevant session, etc. The output of the gender classification model may be a tag of “male” or “female”. The gender classification model may determine gender information based on input content. For example, if a user says “My wife is quite busy recently” in a session, it may be determined that the gender of the user is “male”. If a user's consuming records indicate frequent cosmetics purchases, it may be determined that the user is likely to be “female”.

The gender classification model may also be a SVM model. Training data for this SVM model may be in a form of <user ID, content, tag>, wherein “tag” is an artificially or automatically labelled gender for corresponding content. Features for this SVM model may be the same as or similar with the features of the age prediction model.

In an implementation, a location detection model may be used for determining the location information 1246. The location information 1246 may comprise active or living location of the user. The input to the location detection model may be <content> or <user ID, content>. Here. “content” may refer to data from the session logs 1210, the user consuming records 1220 and the implicit product surveys 1230, e.g., a free-chatting session, a user consuming record, a survey relevant session, etc. The output of the location detection model may be at least one tag of location. The location detection model may determine location information based on input content. For example, if a user says “Do you have any suggestions on restaurants for working lunch around Ueno?” in a session, it may be determined that the user is working around Ueno in Tokyo. If a user's consuming records include a plurality of round-trip tickets from Tokyo to Kyoto, it may be determined that the user is likely to live in Tokyo.

The location detection model may also be a SVM model. Training data for this SVM model may be in a form of <user ID, content, tag>, wherein “tag” is an artificially or automatically labelled location for corresponding content. Features for this SVM model may be the same as or similar with the features of the age prediction model.

In an implementation, a sentiment analysis model may be used for determining the user preferences on products 1248. The input to the sentiment analysis model may be <content> or <user ID, content>. Here, “content” may refer to data from the session logs 1210 and the implicit product surveys 1230, e.g., a free-chatting session or a user's message in the free-chatting session, a survey relevant session or a user's message in the survey relevant session, etc. The output of the sentiment analysis model may be used for forming the user preferences on products 1248. For example, the output of the sentiment analysis model may be in a form of <product name, emotion>, where the emotion may be positive, negative or neutral. The output of the sentiment analysis may also be a list of product names or product keywords for which the user has a positive emotion.

The sentiment analysis model may be a multiple class SVM model. Training data for this SVM model may be in a form of <user ID, content, tag>, wherein “tag” is an artificially or automatically labelled emotion for corresponding content. Features for this SVM model may be the same as or similar with the features of the age prediction model.

FIG. 14 illustrates an exemplary chat window 1400 for conducting an implicit product survey according to an embodiment. The chat window 1400 contains a survey relevant session for determining user preferences on products.

When receiving messages “Good morning” and “I just wake up and feel hungry” input by the user, the chatbot may determine to conduct an implicit product survey on breakfast since “breakfast” is related to expressions “Good morning” and “hungry”. The chatbot may send a response “I just ate breakfast. I ate two bags of Natto”. The response comprises a product “Natto”, and “Natto” is related to “breakfast” since many people eat Natto as a breakfast food. The user may input a further message “What . . . two?! Absolutely not suitable for me”, which may be determined through sentiment analysis as indicating that the user has a negative emotion on Natto. The chatbot may further confirm by “Oh, you do not like Natto?” and receive an explicit answer “Yes, I rarely eat that” from the user. Then, the chatbot may send a message “Actually, I also like to eat bread and rice porridge in the morning” so as to make a further survey on other products and trigger the user's emotion echo through giving the chatbot's own emotional comment on “bread” and “rice porridge”. When receiving an answer “Me too!” from the user, the chatbot may determine through sentiment analysis that the user has a positive emotion on “bread” and “rice porridge” as breakfast.

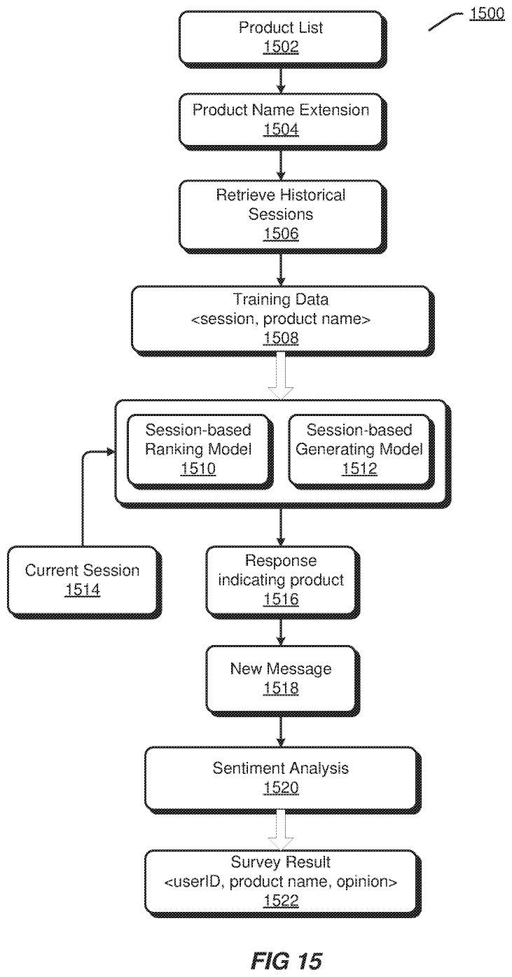

FIG. 15 illustrates an exemplary process 1500 for conducting an implicit product survey according to an embodiment. The process 1500 may comprise several phases, e.g., generating training data, training models that are used for determining products from sessions, applying the models in an implicit product survey, performing sentiment analysis on user's messages, etc.

At 1502, a product list may be obtained. The product list may comprise names of a plurality of products to be surveyed. In an implementation, the product list may be provided by partner entities.

At 1504, a semantic extension may be performed on product names in the product list obtained at 1502. Here, semantic extension intends to extend a product name to a group of product names. The obtained group of product names may include alias names of the product name, names of other products in the same product category, etc. In an implementation, the Word2vec technique may be used for performing semantic extension at 1504.

At 1506, historical sessions between a chatbot and a user may be retrieved, wherein the retrieved historical sessions comprise product names obtained at 1502 or extended product names obtained at 1504.

At 1508, a set of training data may be formed. The training data may be in a form of <session, product name>, wherein the “session” part comprises a historical session retrieved at 1506, and the “product name” part comprises a product name contained in the historical session and/or extended product names corresponding to the product name.

The set of training data may be further used for training models that are for determining products from sessions. The models for determining products from sessions may comprise, such as, a session-based ranking model 1510 or a session-based generating model 1512.

The session-based ranking model 1510 may be trained for determining a product for a given session based on similarities between the given session and reference sessions. For example, similarities between the given session and the reference sessions may be scored respectively, and a product associated with a top-scored reference session may be output.

A Gradient Boosting Decision Tree (GBDT) may be adopted for the session-based ranking model 1510. The GBDT may compute a similarity score of a reference session compared to a given session. The GBDT may be based on various features as discussed below. Here. “S” denotes a given session. “H” denotes a reference session, and each “H” has at least one associated product name determined from the training data obtained at 1508.

In an implementation, a feature in the GBDT may be based on an edit distance in a word level between S and H.

In an implementation, a feature in the GBDT may be based on an edit distance in a character level between S and H. For example, for Asian languages such as Chinese and Japanese, similarity computation may be on a character basis.

In an implementation, a feature in the GBDT may be based on an accumulated Word2vec similarity score, such as a cosine similarity score, between S and H. Generally, Word2vec similarity computation may project words into a dense vector space and then compute a semantic distance between two words through applying cosine function on two vectors corresponding to the two words. In some implementations, before computing a Word2vec similarity score, a high frequency phrase table may be used for pre-processing S and H, e.g., pre-combining high frequency n-grams words in S and H. The following Equations (1) and (2) may be adopted in the computing of the Word2vec similarity score.

Sim₁=Σ_{w in S}(Word2vec(w,vₓ)) Equation (1)

where vₓ is a word or phrase in H and makes Word2vec(w, v) the maximum among all words or phrases v in H.

Sim₂=Σ_{v in H}(Word2vec(wₓ,v)) Equation (2)

where wₓ is a word or phrase in S and makes Word2vec(w, v) the maximum among all words or phrases w in S.

In an implementation, a feature in the GBDT may be based on a BM25 score between S and H. BM25 score is a frequently used similarity score in information retrieval. BM25 may be a bag-of-words retrieval function, and may be used here for ranking a set of reference sessions H based on words of S appearing in each H, regardless of inter-relationship, e.g., relative proximity, between words of S within H. BM25 may be not a single function, and may actually comprise a group of scoring functions with respective components and parameters. An exemplary function is given as follows.

For a given session S containing keywords q₁, . . . , qₙ, a BM25 score of a reference session H may be:

$$Score ( H , S ) = {\sum }_{i = 1}^{n} IDF ( {q}_{i} ) \cdot \frac{f ( {q}_{i} , H ) \cdot ( {k}_{1} + 1 )}{f ( {q}_{i} , H ) + {k}_{1} \cdot ( 1 - b + b \cdot \frac{\vert H \vert}{avg dl} )} \qquad Equation ( 3 )$$

### Here,

f(qᵢ, H) is a term frequency of word qᵢ in H, where f(qᵢ, H)=n if qᵢ occurs n (n≥1) times in H, or otherwise f(qᵢ, H)=0;
   |H| is the number of words in H;
avgdl is an average length of reference sessions in a reference session set M (H∈M);
k₁ and b are free parameters, such as, k₁=1.2 and b=0.75;
IDF(qᵢ) is an inverse document frequency (IDF) weight of word qᵢ. IDF(qᵢ,M)=log(N/|d∈M and qᵢ∈d|), where N is the total number of reference sessions in the reference session set M, e.g., N=|M|. Moreover, |d∈M and qᵢ ∈d| is the number of reference sessions where the word qᵢ appears.

Through Equation (3), a BM25 score of a reference session H may be computed.

In the session-based ranking model 1510, the lengths of S and H may be limited. For a given session S, it may be limited to include R pairs of <user message, chatbot response>, where R may take a value of 1, 3, 5, etc. The larger R is, the longer context should be referred, which may help capturing more information. However, if R is larger, feature extractions will be slower and further slowdown the chatbot's response time to the user. Thus, a trade-off may be made in this scenario according to actual requirements.

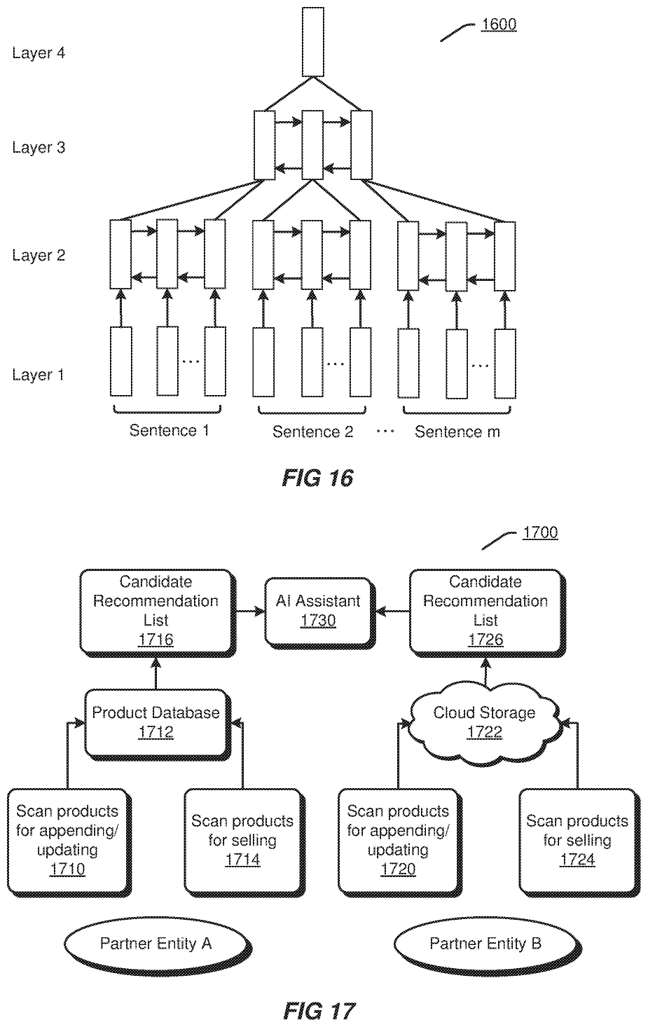

The session-based generating model 1512 may be trained for generating or reasoning a product name for a given session. A hierarchical recurrent neural network (RNN) may be adopted for the session-based generating model 1512. The RNN may encode a session into vectors, and further project the encoded vectors to a list of product names through, e.g., a softmax function. FIG. 16 illustrates an exemplary structure 1600 of a session-based generating model according to an embodiment. The structure 1600 comprises a four-layer neural network, wherein each rectangle represents a vector.

Layer 1 is an input layer. It is assumed that, in Layer 1, there are m sentences from an input session. A group of vectors may be generated in Layer 1, each vector xₜ being a Word2vec style embedding of a word in the m sentences.

Layer 2 is a bi-directional RNN layer for performing recurrent operations among words in each sentence. The purpose of Layer 2 is to convert a whole sentence into a vector. A vector hₜ₊₁ in Layer 2 may be computed as:

hₜ₊₁=RNN(Wₕₕhₜ+Wₓₕxₜ+bₕ) Equation (4)

where Wₕₕ and Wₓₕ are parameter matrices, and bₕ is a bias vector.

As shown in Equation (4), hₜ₊₁ may be computed by firstly linearly combining hₜ and xₜ, and then attaching an elementwise non-linear transformation function. Although RNN(·) is adopted in Equation (4), it should be appreciated that the elementwise non-linear transformation function may also adopt, e.g., tanh or sigmoid.

It is assumed that T is the number of steps to unroll the RNN layer in Layer 2 and h_{T} is a final vector. Considering that the recurrent operations are performed in two directions, i.e., left-to-right and right-to-left, h_{T} may be formed by a concatenation of the two direction vectors.

Layer 3 is another bi-directional RNN layer for performing recurrent operations among the sentences. The purpose of Layer 3 is to obtain a dense vector representation of the whole session. The bi-directional RNN layer in Layer 3 takes h_{T} from Layer 2 as inputs. A vector hₜ₊₁² in Layer 3 may be computed as:

hₜ₊₁²=RNN(Uₕₕhₜ²+bₕ²) Equation (5)

where Uₕₕ is a parameter matrix, and bₕ² is a bias vector.

The output of Layer 3 may be denoted as hₘ², where m is the number of sentences in the input session.

Layer 4 is an output layer. Layer 4 may be configured for determining a probability of each product in a pre-given product list, e.g., the product list obtained at 1502 in FIG. 15. Firstly, an output y may be computed as:

y=U_{hy}hₘ²+b_{y} Equation (6)

where U_{hy} is a parameter matrix, and b_{y} is a bias vector. As shown in Equation (6), y is a linear function of hₘ².

Then, for a probability pᵢ, where i ranges from 1 to the number of products |Q|, it may be computed by using a softmax function to project y into a probability space and ensure P=[p₁, p₂, . . . , p_{|Q|}]^{T} follows a definition of probability.

For error back-propagation, cross-entropy loss which corresponds to a minus log function of P may be applied.

The above discussed structure 1600 is easy to be implemented. However, gradient will vanish as T grows bigger and bigger. For example, gradients in (0, 1) from h_{T} back to h₁ will gradually close to zero, making Stochastic Gradient Descent (SGD)-style updating of parameters infeasible. Thus, in some implementations, to alleviate this problem occurred when using simple non-linear functions, e.g., tanh or sigmoid, other types of functions for expressing hₜ₊₁ by h₁ and x₁ may be adopted, such as, Gated Recurrent Unit (GRU), Long Short-Term Memory (LSTM), etc.

Taking LSTM as an example, the LSTM may address a learning problem of long distance dependencies and a gradient vanishing problem, through augmenting a traditional RNN with a memory cell vector Cₜ∈ [symbol] ⁿ at each time step. One step of the LSTM takes xₜ, hₜ₋₁, cₜ₋₁ as inputs and produces hₜ, cₜ via the following intermediate calculations:

iₜ=σ(Wⁱxₜ+Uⁱhₜ₋₁+bⁱ) Equation (7)

fₜ=σ(W^{f}xₜ+U^{f}hₜ₋₁+b^{f}) Equation (8)

oₜ=σ(W^{o}xₜ+U^{o}hₜ₋₁+b^{o}) Equation (9)

gₜ=tanh(W^{g}xₜ+U^{g}hₜ₋₁+b^{g}) Equation (10)

cₜ=fₜ⊗cₜ₋₁+iₜ⊗gₜ Equation (11)

hₜ=oₜ⊗tanh(cₜ) Equation (12)

where σ(·) and tanh(·) are elementwise sigmoid and hyperbolic tangent functions, ⊗ is an elementwise multiplication operator, and iₜ, fₜ, oₜ denote input gate, forget gate and output gate respectively. When t=1, h₀ and c₀ are initialized to be zero vectors. Parameters to be trained in the LSTM are the matrices W^{j}, U^{j}, and the bias vector b^{j}, where j∈{i, f, o, g}.

Turn back to FIG. 15, after the session-based ranking model 1510 and/or the session-based generating model 1512 are established, the process 1500 may further perform an implicit product survey with a user that is chatting with the chatbot.

At 1514, a current session may be input to the models for determining products from sessions, e.g., the session-based ranking model 1510 or the session-based generating model 1512. The current session may comprise all or a part of user messages and chatbot responses in a session currently proceeding in a chat flow. Alternatively, the current session may only comprise the latest user message.

The session-based ranking model 1510 or the session-based generating model 1512 may determine a name of a product to be surveyed based on the current session, where the current session at least comprises the latest user message. Then, at 1516, a chatbot response indicating the determined product may be formed. Alternatively, in some implementations, if user preferences on products of the user are available, the session-based ranking model 1510 or the session-based generating model 1512 may determine names of a list of products, and further use the user preferences for filtering or re-ranking the list of products, thus determining a product to be surveyed for which the user has a positive emotion.

The chatbot response indicating the determined product obtained at 1516 may be presented to the user, and then a new user message may be obtained at 1518. The new user message may comprise the user's comment on the product being surveyed.

At 1520, sentiment analysis may be performed on the new user message. For example, the sentiment analysis model discussed above may be applied at 1520. Through the sentiment analysis, an item of survey result may be generated in a form of <user ID, product name, emotion>, where “product name” is the name of the product currently being surveyed, and the emotion is determined from the new user message.

Through performing the operations from 1514 to 1520 iteratively, a final survey result may be obtained at 1522. The survey result may comprise the user's emotions on a plurality of products, which may form user preferences on products. Taking the chat flow in FIG. 14 as an example, the survey result may include: <user ID. Natto, negative>, <user ID, bread, positive>, <user ID, rice porridge, positive>, etc.

FIG. 17 illustrates an exemplary process 1700 for obtaining a candidate recommendation list according to an embodiment. Herein, “candidate recommendation list” may comprise at least one candidate recommended product and corresponding promotion information, and may be used for determining product recommendation information. For example, when determining product recommendation information, an AI assistant may select, from the candidate recommended products in the candidate recommendation list, one or more products that are to be recommended to a user.

There may be two approaches for obtaining the candidate recommendation list, one is to receive the candidate recommendation list from a partner entity, another is to determine the candidate recommendation list from a cloud storage. FIG. 17 shows these two approaches in connection with Partner Entity A and Partner Entity B respectively.

As for Partner Entity A, at 1710, products may be scanned by, e.g., a scanning gun. Through the scanning at 1710, information of new products may be appended to a product database 1712, or promotion information of existing products may be updated in the product database 1712. Each product may have a unique bar code or QR code, which may be used for identifying the product. The product database 1712 may be maintained by Partner Entity A. At 1714, when a user picks up and buys some products, these products may be scanned again at, e.g., a cash register. Thus, status of these products in the product database 1712 may be changed to “completed” or inactive for forbidding to be operated any more. An owner or operator of Partner Entity A may check the product database 1712 for deciding what products may be promoted and what promotion can be applied. In other words, a candidate recommendation list may be determined at 1716 from the product database 1712 that is maintained by Partner Entity A. The candidate recommendation list may be further provided to the AI assistant 1730 periodically or in response to a request.

As for Partner Entity B, scanning operations 1720 and 1724 are similar with the scanning operations 1710 and 1714 respectively, except that product information obtained through scanning operations 1720 and 1724 is maintained in cloud storage instead of in a product database maintained by the partner entity. In this case, the AI assistant 1730 may determine a candidate recommendation list at 1726 from the cloud storage automatically. In an implementation, a predefined promotion rule may be provided by an owner or operator of Partner Entity B, and the AI assistant 1730 may decide what products are to be promoted and what promotion can be applied according to the predefined promotion rule. For example, a promotion rule for “bread” products having 5 days of storing period may be defined as: 20% discount at the 4-th day and 50% discount at the final day. Then, the AI assistant may periodically compute how long it takes since the first time of appending a “bread” product, and then decide a corresponding promotion solution for this product based on the promotion rule for bread products.

The received or determined candidate recommendation list may be further used by the AI assistant for determining product recommendation information, which will be discussed below.

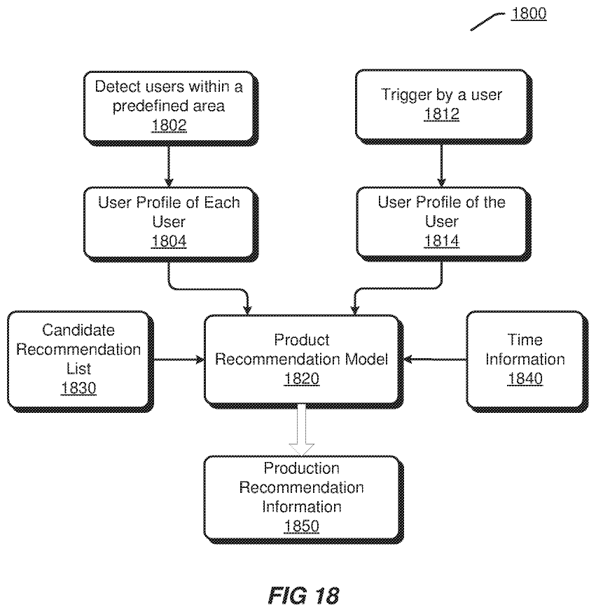

FIG. 18 illustrates an exemplary process 1800 for determining product recommendation information according to an embodiment.

In an implementation, product recommendation may be initiated by an AI assistant at a partner entity proactively for users locating near the partner entity. For example, at 1802, it may be determined whether one or more terminal devices are within a predefined area near the partner entity, thus detecting whether one or more users are near the partner entity. For each detected user, a user profile of the user may be obtained.

In an implementation, product recommendation from nearby partner entities may be requested and thus triggered by a user proactively. Moreover, product recommendation may also be triggered by a user who is inside a partner entity. For example, at 1812, a trigger from a user may be received. Then, at 1814, a user profile of the user may be obtained.

The process 1800 comprises using a product recommendation model 1820 for determining at least one recommended product that is to recommend to a user and associated with at least one partner entity. The product recommendation model 1820 may be a learning-to-rank (LTR) model. Features of the LTR model may comprise at least one of user profile, candidate recommendation list, and time information. Thus, when applying, inputs to the LTR model may comprise at least one of the user profile obtained at 1804 or 1814, a candidate recommendation list 1830 associated with the partner entity, and time information 1840. The user profile may be generated through the process in FIG. 12, and comprise at least one of user ID, age information, gender information, location information and user preferences on products of the user. The candidate recommendation list 1830 may be determined through the process in FIG. 17, and comprise candidate recommended products and corresponding promotion information of the partner entity. The time information 1840 may comprise the current time point and/or average time that users spent in the partner entity.

The product recommendation model 1820 may select one or more candidate recommended products from the candidate recommendation list as the at least one recommended product, based at least on considerations of the user profile and/or the time information. In an implementation, the selected candidate recommended products may be suitable for the user's age, gender or location, and based on user preferences, those candidate recommended products having positive emotions from the user may be given higher weights. In an implementation, the selecting of candidate recommended products may be time-sensitive. For example, it is preferred to recommend coffee in the morning, to recommend box lunch during the lunch time, and to recommend energy-recovering related foods during the dinner time. For example, average time that the user spent in the partner entity may be used for judging whether the user makes shopping decisions fast or not, and thus “light-decision-making necessary” or “heavy-decision-making necessary” products may be differently weighted accordingly.

Moreover, although not shown in FIG. 18, the selecting of candidate recommended products by the product recommendation model 1820 may be further based on the user's message. Here. “message” may refer to a current message of the user and/or one or more historical messages of the user. In this case, the establishing of the LTR model may be further based on at least one of:
Word n-grams: Unigrams and bigrams for words in the message are extracted.
Character n-grams: Character n-grams, e.g., 4-grams and 5-grams, are extracted for each word in the message.
Word skip-grams: Those words having no meaning in the message may be skipped so as to faster matching speed without influencing matching results. For example, for 3-grams and 4-grams in the message, one word may be replaced by * to indicate a presence of non-contiguous words.
Brown cluster n-grams: Brown clustering is used for representing words in the message, and extracting unigrams and bigrams as features.
Part-of-speech (POS) tags: Presence or absence of POS tag is used as a binary feature.
Social network related words: Numbers of hashtags, emoticons, elongated words, and punctuations in the message are used as features.
Word2vec cluster n-grams: A Word2vec tool is used to learn, e.g., 100-dimension word embedding from a social network dataset. Then, K-means algorithm and L2 distance of word vectors may be used for clustering a million-level vocabulary into, e.g., 200 classes. These classes are used for representing generalized words in the message.

Moreover, although not shown in FIG. 18, the selecting of candidate recommended products by the product recommendation model 1820 may be further based on a moving direction of the user. Herein. “moving direction” may refer to a direction relative to the partner entity. For example, if a detector at the partner entity can detect that the user always passes through the partner entity from east to west in the morning and from west to east in the evening, then it can be determined that the user may live in the east of the partner entity and work in the west of the partner entity. Thus, different kinds of products may be recommended based on different moving directions of the user. For example, if it is detected that the user is currently moving from east to west, i.e., leaving home to work, then higher weights may be given to those candidate recommended products that are relatively light and cheaper and fast for buying without the need of choosing or long-time decision making, such as, coffee, tea, salad, etc. For example, if it is detected that the user is currently moving from west to east, i.e., getting home from work, then higher weights may be given to those candidate recommended products that are relatively heavy, such as, wines, beers, etc.

According to the process 1800, after the product recommendation model 1820 determines at least one recommended product, production recommendation information may be formed at 1850, which may include the determined at least one recommended product and corresponding promotion information retrieved from the candidate recommendation list. Therefore, the production recommendation information formed at 1850 may be further provided to the user.

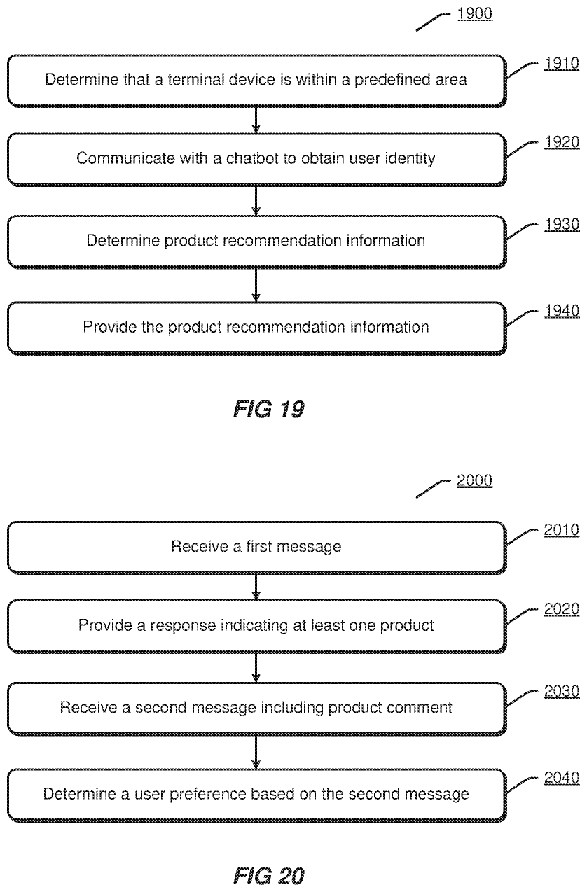

FIG. 19 illustrates a flowchart of an exemplary method 1900 for facilitating product recommendation in automated chatting according to an embodiment. The method 1900 may be implemented by an AI assistant deployed at a partner entity.

At 1910, it may be determined that a terminal device is within a predefined area.

At 1920, a user identity may be obtained through communicating with a chatbot on the terminal device.

At 1930, product recommendation information associated with the user identity may be determined.

At 1940, the product recommendation information may be provided to the chatbot.

In an implementation, the product recommendation information may be determined through a LTR model based on at least one of: a candidate recommendation list, a user profile associated with the user identity, and time information.

The method 1900 may further comprise: receiving the candidate recommendation list from a partner entity, or determining the candidate recommendation list according to a predefined promotion rule, wherein the candidate recommendation list comprises at least one candidate recommended product and corresponding promotion information. The determining the product recommendation information may comprise: selecting one or more candidate recommended products from the candidate recommendation list through the LTR model; and forming the product recommendation information based on the selected candidate recommended products and corresponding promotion information.

In an implementation, the user profile may comprise at least one of: user identity, age information, gender information, location information and user preferences on products. The user profile may be determined based on at least one of: user consuming records at a partner entity, session logs at the chatbot, and implicit product surveys conducted by the chatbot.

In an implementation, the method 1900 may further comprise: receiving, through a user interface, a message comprising a query on at least one product; determining second product recommendation information based at least on the message; and presenting the second product recommendation information through the user interface.

It should be appreciated that the method 1900 may further comprise any steps/processes for facilitating product recommendation in automated chatting according to the embodiments of the present disclosure as mentioned above.

FIG. 20 illustrates a flowchart of an exemplary method 2000 for facilitating product recommendation in automated chatting according to an embodiment. The method 2000 may be implemented by a chatbot at a terminal device of a user.

At 2010, a first message may be received in a chat flow.

At 2020, a response to the first message may be provided, wherein the response indicates at least one product determined based at least on the first message.

At 2030, a second message including a comment on the at least one product may be received.

At 2040, a user preference on the at least one product may be determined based at least on the second message.

In an implementation, the method 2000 may further comprise: presenting product recommendation information in the chat flow, the product recommendation information being determined based at least on the user preference.

In an implementation, the at least one product may be determined through a session-based ranking model operable for scoring similarity between a current session in the chat flow and at least one reference session; and selecting one or more reference products associated with a top-scored reference session as the at least one product.

In an implementation, the at least one product may be determined through a session-based generating model operable for: generating the at least one product's name based on a current session in the chat flow through a RNN. The RNN may comprise: a first bi-directional RNN layer, for performing recurrent operations among words in each sentence of the current session; and a second bi-directional RNN layer, for performing recurrent operations among sentences in the current session.

In an implementation, the method 2000 may further comprise: performing semantic extension on the at least one product's name, to obtain a group of product names; and associating the user preference with the group of product names.

In an implementation, the determining the user preference may comprise: determining a positive, negative or neural emotion on the at least one product, through performing sentiment analysis on at least the second message.

In an implementation, the response may be a part of an implicit product survey.

It should be appreciated that the method 2000 may further comprise any steps/processes for facilitating product recommendation in automated chatting according to the embodiments of the present disclosure as mentioned above.

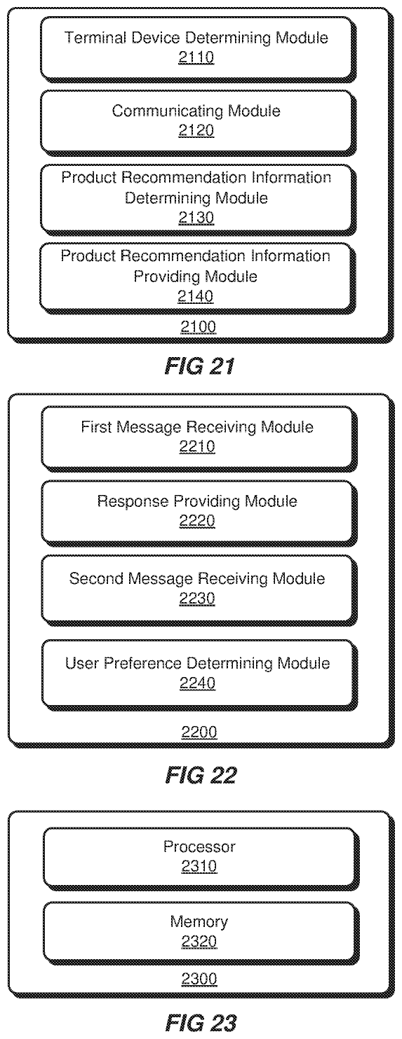

FIG. 21 illustrates an exemplary apparatus 2100 for facilitating product recommendation in automated chatting according to an embodiment.

The apparatus 2100 may comprise: a terminal device determining module 2110, for determining that a terminal device is within a predefined area; a communicating module 2120, for communicating with a chatbot on the terminal device to obtain a user identity; a product recommendation information determining module 2130, for determining product recommendation information associated with the user identity; and a product recommendation information providing module 2140, for providing the product recommendation information to the chatbot.

In an implementation, the product recommendation information may be determined through a LTR model based on at least one of: a candidate recommendation list, a user profile associated with the user identity, and time information.

Moreover, the apparatus 2100 may also comprise any other modules configured for performing any operations of the methods for facilitating product recommendation in automated chatting according to the embodiments of the present disclosure as mentioned above.

FIG. 22 illustrates an exemplary apparatus 2200 for facilitating product recommendation in automated chatting according to an embodiment.

The apparatus 2200 may comprise: a first message receiving module 2210, for receiving a first message in a chat flow; a response providing module 2220, providing a response to the first message, the response indicating at least one product determined based at least on the first message; a second message receiving module 2230, for receiving a second message including a comment on the at least one product; and a user preference determining module 2240, for determining a user preference on the at least one product based at least on the second message.

In an implementation, the apparatus 2200 may further comprise: a product recommendation information presenting module, for presenting product recommendation information in the chat flow, the product recommendation information being determined based at least on the user preference.

In an implementation, the at least one product may be determined through a session-based generating model operable for: generating the at least one product's name based on a current session in the chat flow through a RNN.

Moreover, the apparatus 2200 may also comprise any other modules configured for performing any operations of the methods for facilitating product recommendation in automated chatting according to the embodiments of the present disclosure as mentioned above.

FIG. 23 illustrates an exemplary apparatus 2300 for facilitating product recommendation in automated chatting according to an embodiment.

The apparatus 2300 may comprise at least one processor 2310. The apparatus 2300 may further comprise a memory 2320 that is connected with the processor 2310. The memory 2320 may store computer-executable instructions that, when executed, cause the processor 2310 to perform any operations of the methods for facilitating product recommendation in automated chatting according to the embodiments of the present disclosure as mentioned above.

The embodiments of the present disclosure propose an electronic apparatus. The electronic apparatus may comprise: a detector, for detecting whether a terminal device is within a predefined area; a memory, for storing computer-executable instructions; and a processor, for executing the computer-executable instructions. When executing the computer-executable instructions, the processor may operate for: determining that the terminal device is within the predefined area based on the detection of the detector; communicating with a chatbot on the terminal device to obtain a user identity; determining product recommendation information associated with the user identity; and providing the product recommendation information to the chatbot.

The embodiments of the present disclosure may be embodied in a non-transitory computer-readable medium. The non-transitory computer-readable medium may comprise instructions that, when executed, cause one or more processors to perform any operations of the methods for facilitating product recommendation in automated chatting according to the embodiments of the present disclosure as mentioned above.

It should be appreciated that all the operations in the methods described above are merely exemplary, and the present disclosure is not limited to any operations in the methods or sequence orders of these operations, and should cover all other equivalents under the same or similar concepts.

It should also be appreciated that all the modules in the apparatuses described above may be implemented in various approaches. These modules may be implemented as hardware, software, or a combination thereof. Moreover, any of these modules may be further functionally divided into sub-modules or combined together.

Processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in the present disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout the present disclosure. The functionality of a processor, any portion of a processor, or any combination of processors presented in the present disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, threads of execution, procedures, functions, etc. The software may reside on a computer-readable medium. A computer-readable medium may include, by way of example, memory such as a magnetic storage device (e.g., hard disk, floppy disk, magnetic strip), an optical disk, a smart card, a flash memory device, random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout the present disclosure, the memory may be internal to the processors (e.g., cache or register).

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein. All structural and functional equivalents to the elements of the various aspects described throughout the present disclosure that are known or later come to be known to those of ordinary skill in the art are expressly incorporated herein by reference and are intended to be encompassed by the claims.

What is claimed is:

1. A method for facilitating product recommendation in automated chatting, comprising:
determining that a terminal device is within a predefined area;
communicating with a chatbot on the terminal device to obtain a user identity;
determining product recommendation information associated with the user identity; and
providing the product recommendation information to the chatbot.

2. The method of claim 1, wherein the product recommendation information is determined through a learning-to-rank (LTR) model based on at least one of: a candidate recommendation list, a user profile associated with the user identity, and time information.

3. The method of claim 2, further comprising:
receiving the candidate recommendation list from a partner entity, or determining the candidate recommendation list according to a predefined promotion rule,
wherein the candidate recommendation list comprises at least one candidate recommended product and corresponding promotion information.

4. The method of claim 3, wherein the determining the product recommendation information comprises:
selecting one or more candidate recommended products from the candidate recommendation list through the LTR model; and
forming the product recommendation information based on the selected candidate recommended products and corresponding promotion information.

5. The method of claim 2, wherein
the user profile comprises at least one of: user identity, age information, gender information, location information and user preferences on products, and
the user profile is determined based on at least one of: user consuming records at a partner entity, session logs at the chatbot, and implicit product surveys conducted by the chatbot.

6. The method of claim 1, further comprising:
receiving, through a user interface, a message comprising a query on at least one product;
determining second product recommendation information based at least on the message; and
presenting the second product recommendation information through the user interface.

7. A method for facilitating product recommendation in automated chatting, comprising:
receiving a first message in a chat flow;
providing a response to the first message, the response indicating at least one product determined based at least on the first message;
receiving a second message including a comment on the at least one product; and
determining a user preference on the at least one product based at least on the second message.

8. The method of claim 7, further comprising:
presenting product recommendation information in the chat flow, the product recommendation information being determined based at least on the user preference.

9. The method of claim 7, wherein the at least one product is determined through a session-based ranking model operable for:
scoring similarity between a current session in the chat flow and at least one reference session; and
selecting one or more reference products associated with a top-scored reference session as the at least one product.

10. The method of claim 7, wherein the at least one product is determined through a session-based generating model operable for:
generating the at least one product's name based on a current session in the chat flow through a Recurrent Neural Network (RNN).

11. The method of claim 10, wherein the RNN comprises:
a first bi-directional RNN layer, for performing recurrent operations among words in each sentence of the current session; and
a second bi-directional RNN layer, for performing recurrent operations among sentences in the current session.

12. The method of claim 7, further comprising:
performing semantic extension on the at least one product's name, to obtain a group of product names; and
associating the user preference with the group of product names.

13. The method of claim 7, wherein the determining the user preference comprises:
determining a positive, negative or neural emotion on the at least one product, through performing sentiment analysis on at least the second message.

14. The method of claim 7, wherein the response is a part of an implicit product survey.

15. An apparatus for facilitating product recommendation in automated chatting, comprising:
a terminal device determining module, for determining that a terminal device is within a predefined area;
a communicating module, for communicating with a chatbot on the terminal device to obtain a user identity;
a product recommendation information determining module, for determining product recommendation information associated with the user identity; and
a product recommendation information providing module, for providing the product recommendation information to the chatbot.

16. The apparatus of claim 15, wherein the product recommendation information is determined through a learning-to-rank (LTR) model based on at least one of: a candidate recommendation list, a user profile associated with the user identity, and time information.

17. An apparatus for facilitating product recommendation in automated chatting, comprising:
a first message receiving module, for receiving a first message in a chat flow;
a response providing module, providing a response to the first message, the response indicating at least one product determined based at least on the first message;
a second message receiving module, for receiving a second message including a comment on the at least one product; and
a user preference determining module, for determining a user preference on the at least one product based at least on the second message.

18. The apparatus of claim 17, further comprising:
a product recommendation information presenting module, for presenting product recommendation information in the chat flow, the product recommendation information being determined based at least on the user preference.

19. The apparatus of claim 17, wherein the at least one product is determined through a session-based generating model operable for:
generating the at least one product's name based on a current session in the chat flow through a Recurrent Neural Network (RNN).

20. An electronic apparatus, comprising:
a detector, for detecting whether a terminal device is within a predefined area;
a memory, for storing computer-executable instructions; and
a processor, for executing the computer-executable instructions to operate for:
determining that the terminal device is within the predefined area based on the detection of the detector;
communicating with a chatbot on the terminal device to obtain a user identity;
determining product recommendation information associated with the user identity; and
providing the product recommendation information to the chatbot.
